(19) United States
(12) Patent Application Publication
(10) Pub. No.: US 2002/0136931 A1
(43) Pub. Date: Sep. 26, 2002

(54) Acousto-optic structure, device including the structure, and methods of forming the device and structure

(75) Inventors: Kurt W. Eisenbeiser, Tempe, AZ (US); Jeffrey M. Finder, Chandler, AZ (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/813,779

(22) Filed: Mar. 20, 2001

(51) Int. Cl. B32B 9/00

(52) U.S. Cl. 428/697; 428/450; 428/642; 428/701; 428/702; 428/446

(57) ABSTRACT

High quality epitaxial layers of monocrystalline piezoelectric materials (106) and acousto-optic materials (108) can be grown overlying monocrystalline substrates (102) such as large silicon wafers by forming a compliant substrate for growing the monocrystalline layers. One way to achieve the formation of a compliant substrate includes first growing an accommodating buffer layer (104) on a silicon wafer (102). The accommodating buffer layer (104) is a layer of monocrystalline oxide spaced apart from the silicon wafer by an amorphous interface layer of silicon oxide (110). The amorphous interface layer dissipates strain and permits the growth of a high quality monocrystalline oxide accommodating buffer layer. Acousto-Optic devices (1018) may be formed using the piezoelectric materials (106) and the acousto-optic materials (108) and integrated with devices formed within the substrate (102) or other devices (1016, 1018) formed using other epitaxially grown monocrystalline layers.

### FIELD OF THE INVENTION

This invention relates generally to semiconductor structures and devices and to a method for their fabrication, and more specifically to semiconductor structures and devices and to the fabrication and use of semiconductor structures, devices, and integrated circuits that include an acousto-optic element formed over an underlying substrate.

### BACKGROUND OF THE INVENTION

Acousto-optic devices may be used for a variety of applications. For example, acousto-optic devices may be used to form Bragg cells, acousto-optic switches, acousto-optic modulators, laser tuning devices, tunable filter devices, deflectors, and the like. Generally, the acousto-optic device includes a piezoelectric portion to create an acoustic signal and an acousto-optic portion that changes properties as a result of the applied acoustic signal.

Typical acousto-optic devices are formed either by coupling a piezoelectric structure to an acousto-optic structure or forming a monolithic acousto-optic device on a piezoelectric substrate. The acousto-optic device is then coupled to microelectronic circuits, such as driver circuits for the piezoelectric material and coupled to optical components such as lasers and photodetectors.

Circuits including an acousto-optic device are typically formed by coupling discrete microelectronic components to the acousto-optic device—e.g., by attaching a microelectronic component and an acousto-optic device to a substrate and electrically coupling the devices together. Integrating microelectronic components and acousto-optic devices in this manner is relatively expensive because of costs associated with separately forming and attaching the respective devices to a substrate. Accordingly, improved techniques for integrating microelectronic components and acousto-optic devices and other optical components are desired.

Piezoelectric and acousto-optic materials are relatively expensive in bulk form compared to other materials used to form microelectronic devices. Because of their present generally high cost and low availability in bulk form, for many years attempts have been made to grow thin films of these materials on a foreign substrate. To achieve optimal characteristics of the materials, however, monocrystalline films of high crystalline quality are desired. Attempts have been made, for example, to grow layers of a monocrystalline piezoelectric material on substrates such as silicon. These attempts have generally been unsuccessful because lattice mismatches between the host crystal and the grown crystal have caused the resulting thin film of piezoelectric material to be of low crystalline quality.

If large area thin films of high quality piezoelectric and materials suitable for forming the acousto-optic structures were available at low cost, a variety of semiconductor devices could advantageously be fabricated in or using the films at a low cost compared to the cost of fabricating such devices beginning with a bulk wafers of piezoelectric material and/or acousto-optic structure materials. In addition, if thin films of high quality monocrystalline piezoelectric and acousto-optic structure materials could be realized beginning with a bulk wafer such as a silicon wafer, an integrated acousto-optic device structure could be achieved that took advantage of the best properties of both the silicon and the high quality thin films. A further benefit would be the monolithic integration of the acousto-optic device and the silicon wafer with compound semiconductor photonic components such as lasers and photodetectors.

### BRIEF DESCRIPTION OF THE DRAWINGS

The present invention is illustrated by way of example and not limitation in the accompanying figures, in which like references indicate similar elements, and in which:

FIGS. 1, 2, 3, and 4 illustrate schematically, in cross section, device structures in accordance with various embodiments of the invention;

FIG. 5 illustrates graphically the relationship between maximum attainable film thickness and lattice mismatch between a host crystal and a grown crystalline overlayer;

FIG. 6 illustrates a high resolution Transmission Electron Micrograph of a structure including a monocrystalline accommodating buffer layer;

FIG. 7 illustrates an x-ray diffraction spectrum of a structure including a monocrystalline accommodating buffer layer;

FIG. 8 illustrates a high resolution Transmission Electron Micrograph of a structure including an amorphous oxide layer;

FIG. 9 illustrates an x-ray diffraction spectrum of a structure including an amorphous oxide layer; and

FIG. 10 illustrates schematically, in cross section, a device structure including a light emitting device, a light receiving device, and an acousto-optic element in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

FIG. 1 illustrates schematically, in cross section, a portion of a semiconductor structure 100 in accordance with an embodiment of the invention. Semiconductor structure 100 includes a monocrystalline substrate 102, an accommodating buffer layer 104 comprising a monocrystalline material, a piezoelectric layer 106, and an acousto-optic layer 108. In this context, the term “monocrystalline” shall have the meaning commonly used within the semiconductor industry. The term shall refer to materials that are a single crystal or that are substantially a single crystal and shall include those materials having a relatively small number of defects such as dislocations and the like as are commonly found in substrates of silicon or germanium or mixtures of silicon and germanium and epitaxial layers of such materials commonly found in the semiconductor industry.

In accordance with one embodiment of the invention, structure 100 also includes an amorphous intermediate layer 110 positioned between substrate 102 and accommodating buffer layer 104. Structure 100 may also include a template layer 112 between the accommodating buffer layer and piezoelectric material layer 106. As will be explained more fully below, the template layer helps to initiate the growth of the monocrystalline material layer on the accommodating buffer layer. The amorphous intermediate layer helps to relieve the strain in the accommodating buffer layer and by doing so, aids in the growth of a high crystalline quality accommodating buffer layer.

Substrate 102, in accordance with an embodiment of the invention, is a monocrystalline semiconductor or compound semiconductor wafer, preferably of large diameter. The wafer can be of, for example, a material from Group IV of the periodic table, and preferably a material from Group IVB. Examples of Group IV semiconductor materials include silicon, germanium, mixed silicon and germanium, mixed silicon and carbon, mixed silicon, germanium and carbon, and the like. Preferably substrate 102 is a wafer containing silicon or germanium, and most preferably is a high quality monocrystalline silicon wafer as used in the semiconductor industry. Accommodating buffer layer 104 is preferably a monocrystalline oxide or nitride material epitaxially grown on the underlying substrate. In accordance with one embodiment of the invention, amorphous intermediate layer 110 is grown on substrate 102 at the interface between substrate 102 and the growing accommodating buffer layer by the oxidation of substrate 102 during the growth of layer 104. The amorphous intermediate layer serves to relieve strain that might otherwise occur in the monocrystalline accommodating buffer layer as a result of differences in the lattice constants of the substrate and the buffer layer. As used herein, lattice constant refers to the distance between atoms of a cell measured in the plane of the surface. If such strain is not relieved by the amorphous intermediate layer, the strain may cause defects in the crystalline structure of the accommodating buffer layer. Defects in the crystalline structure of the accommodating buffer layer, in turn, would make it difficult to achieve a high quality crystalline structure in layers 106 and 108.

Accommodating buffer layer 104 is preferably a monocrystalline oxide or nitride material selected for its crystalline compatibility with the underlying substrate and with the overlying material layer. For example, the material could be an oxide or nitride having a lattice structure closely matched to the substrate and to the subsequently applied monocrystalline material layer. Materials that are suitable for the accommodating buffer layer include metal oxides such as the alkaline earth metal titanates, alkaline earth metal zirconates, alkaline earth metal hafnates, alkaline earth metal tantalates, alkaline earth metal ruthenates, alkaline earth metal niobates, alkaline earth metal vanadates, perovskite oxides such as alkaline earth metal tin-based perovskites, lanthanum aluminate, lanthanum scandium oxide, and gadolinium oxide. Additionally, various nitrides such as gallium nitride, aluminum nitride, and boron nitride may also be used for the accommodating buffer layer. Most of these materials are insulators, although strontium ruthenate, for example, is a conductor. Generally, these materials are metal oxides or metal nitrides, and more particularly, these metal oxides or nitrides typically include at least two different metallic elements. In some specific applications, the metal oxides or nitrides may include three or more different metallic elements.

Amorphous interface layer 110 is preferably an oxide formed by the oxidation of the surface of substrate 102, and more preferably is composed of a silicon oxide. The thickness of layer 110 is sufficient to relieve strain attributed to mismatches between the lattice constants of substrate 102 and accommodating buffer layer 104. Typically, layer 110 has a thickness in the range of approximately 0.5-5 nm.

The material for piezoelectric material layer 106 can be selected, as desired, for a particular structure or application. In accordance with an exemplary embodiment of the present invention, piezoelectric material layer 106 includes a material with a cubic structure, such as lead zirconium titanium oxide, Pb(Zr,Ti)O₃, which closely matches the crystalline structure of underlying layer 104. In a particularly preferred embodiment of the invention, layer 106 is about 30-500 nm thick and the composition is PbZr_{0.4}Ti_{0.6}O₃. Layer 106 may also include other piezoelectric materials such as lithium niobate, LiNbO₃, or lithium tantalum oxide, LiTaO₃.

Materials for layer 108 may similarly vary from application to application. In accordance with one embodiment of the invention, layer 108 includes a semiconductor material such as GaAs or Ge, or other material such as TeO₂. The thickness of layer 108 is preferably about 0.1 um to about 10 um.

Appropriate materials for template 112 are discussed below. Suitable template materials chemically bond to the surface of the accommodating buffer layer 104 at selected sites and provide sites for the nucleation of the epitaxial growth of monocrystalline material layer 106. When used, template layer 112 has a thickness ranging from about 1 to about 10 monolayers. A device structure in accordance with the invention may also include a template layers 106 and 108.

FIG. 2 illustrates, in cross section, a portion of a semiconductor structure 200 in accordance with a further embodiment of the invention. Structure 200 is similar to the previously described semiconductor structure 100, except that the positions of piezoelectric layer 106 and acousto-optic layer 108 have been transposed, such that layer 108 is proximate the accommodating buffer layer and layer 106 is overlying layer 108.

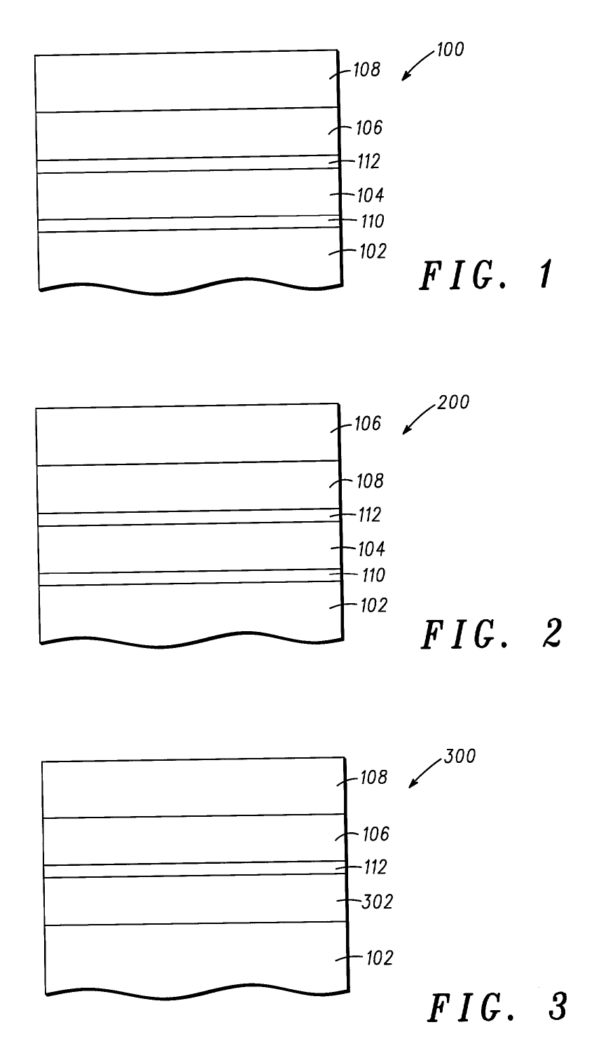

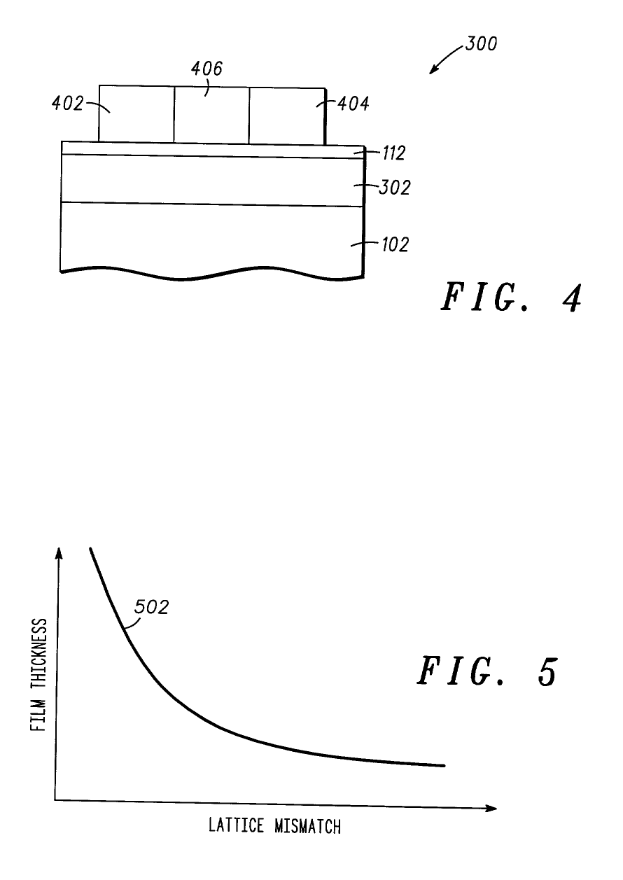

FIG. 3 schematically illustrates, in cross section, a portion of a semiconductor structure 300 in accordance with another exemplary embodiment of the invention. Structure 300 is similar to structure 100, except that structure 300 includes an amorphous layer 302, rather than accommodating buffer layer 104 and amorphous interface layer 110. Although not illustrated, a structure in accordance with another embodiment of the present invention includes layer 108 proximate layer 302 and layer 106 formed overlying layer 108.

As explained in greater detail below, amorphous layer 302 may be formed by first forming an accommodating buffer layer and an amorphous interface layer in a similar manner to that described above. Monocrystalline layer 106 or a portion thereof is then formed (by epitaxial growth) overlying the monocrystalline accommodating buffer layer. The accommodating buffer layer is then exposed to an anneal process to convert the monocrystalline accommodating buffer layer to an amorphous layer. Amorphous layer 302 formed in this manner comprises materials from both the accommodating buffer and interface layers, which amorphous layers may or may not amalgamate. Thus, layer 302 may comprise one or two amorphous layers. Formation of amorphous layer 302 between substrate 102 and piezoelectric layer 106 relieves stresses between layers 102 and 106 and provides a true compliant substrate for subsequent processing.

The processes previously described above in connection with FIGS. 1 and 2 are adequate for growing monocrystalline material layers over a monocrystalline substrate. However, the process described in connection with FIG. 3, which includes transforming a monocrystalline accommodating buffer layer to an amorphous oxide layer, may be better for growing monocrystalline material layers because it allows any strain in layer 106 to relax.

In accordance with one embodiment of the present invention, a portion of layer 106 serves as an anneal cap during layer 302 formation and as a template for continued growth of layer 106. Accordingly, the portion is preferably thick enough to provide a suitable template for layer 106 growth (at least one monolayer) and thin enough to allow the portion to form as a substantially defect free monocrystalline layer.

FIG. 4 illustrates a structure 400 in accordance with yet another embodiment of the invention. Structure 400 is similar to structure 300, except that structure 400 includes piezoelectric structures 402 and 404 and an acousto-optic structure 406 interposed between structures 402 and 404. In accordance with this embodiment, both the piezoelectric elements and the acousto-optic elements are formed overlying layer 302. Structure 400 may be formed by using layer 112 as a cap layer to form layer 302 and as a template for both piezoelectric material and acousto-optic material. The separate structures may be formed using selective growth techniques (e.g., only depositing piezoelectric or acousto-optic material in desired locations) or by initially forming one set of structures using deposition and etch techniques and subsequently forming the second set of structures using selective deposition or additional deposition and etch processes.

The following non-limiting, illustrative examples illustrate various combinations of materials useful in structures 100, 200, 300, and 400 in accordance with various alternative embodiments of the invention. These examples are merely illustrative, and it is not intended that the invention be limited to these illustrative examples.

### EXAMPLE 1

In accordance with one embodiment of the invention, monocrystalline substrate 102 is a silicon substrate oriented in the (100) direction. The silicon substrate can be, for example, a silicon substrate as is commonly used in making complementary metal oxide semiconductor (CMOS) integrated circuits having a diameter of about 200-300 mm. In accordance with this embodiment of the invention, accommodating buffer layer 104 is a monocrystalline layer of Sr_{z}Ba_{1-z}TiO₃ where z ranges from 0 to 1 and the amorphous intermediate layer is a layer of silicon oxide (SiOₓ) formed at the interface between the silicon substrate and the accommodating buffer layer. The value of z is selected to obtain one or more lattice constants closely matched to corresponding lattice constants of the subsequently formed layer 106. The accommodating buffer layer can have a thickness of about 2 to about 100 nanometers (nm) and preferably has a thickness of about 5 nm. Layers thicker than 100 nm usually provide little additional benefit while increasing cost unnecessarily; however, thicker layers may be fabricated if needed. The amorphous intermediate layer of silicon oxide can have a thickness of about 0.5-5 nm, and preferably a thickness of about 1 to 2 nm.

In accordance with this embodiment of the invention, piezoelectric material layer 106 includes a monocrystalline film comprising Pb(Zr,Ti)O₃, having a thickness of about 1 nm to about 100 micrometers (μm) and preferably a thickness of about 0.5 μm to 10 μm. The thickness generally depends on the application for which the layer is being prepared. To facilitate the epitaxial growth of the Pb(Zr,Ti)O₃ on the monocrystalline oxide, a template layer is formed by capping the oxide layer. Template layer 112 is preferably 1-2 monolayers of titanium, 1-2 monolayers of titanium-oxygen or 1-2 monolayers of strontium-oxygen.

Layer 108 is then epitaxially formed overlying layer 106. In accordance with one embodiment of the invention, layer 108 includes GaAs, having a thickness of about 1 nm to about 100 μm and preferably a thickness of about 0.5 μm to 10 μm.

### EXAMPLE 2

In accordance with another embodiment of the invention, layers 102-110 are the same as those described above, and layers 106 and 108 are transposed to form structure 200, illustrated in FIG. 2. In this case, template layer 112 comprises 1-10 monolayers of Ti—As, Sr—O—As, Sr—Ga—O, or Sr—Al—O.

In accordance with one aspect of this embodiment, layer 112 also includes a surfactant and capping layer. The surfactant layer may comprise, but is not limited to, elements such as Al, In and Ga, but will be dependent upon the composition of layer 104 and the overlying layer of monocrystalline material for optimal results. In one exemplary embodiment, Al is used for the surfactant layer and functions to modify the surface and surface energy of layer 104. Preferably, the surfactant layer is epitaxially grown, to a thickness of one to two monolayers, over layer 104.

The surfactant layer is exposed to a gas such as arsenic, for example, to form the capping layer. The surfactant layer may be exposed to a number of materials to create the capping layer, such as elements which include, but are not limited to, As, P, Sb and N. The surfactant layer and the capping layer combine to form template layer 112. Monocrystalline acousto-optic material layer 108, which in this example is a compound semiconductor such as GaAs, is then deposited onto template 112.

### EXAMPLE 3

This example provides exemplary materials useful in structure 300, as illustrated in FIG. 3. Substrate material 102, template layer 112, and monocrystalline material layers 106 and 108 may be the same as those described above in connection with example 1.

Amorphous layer 302 is an amorphous oxide layer which is suitably formed of a combination of amorphous intermediate layer materials (e.g., layer 110 materials as described above) and accommodating buffer layer materials (e.g., layer 104 materials as described above). For example, amorphous layer 302 may include a combination of SiOₓ and Sr_{z}Ba_{1-z}TiO₃ (where z ranges from 0 to 1), which combine or mix, at least partially, during an anneal process to form amorphous oxide layer 302.

The thickness of amorphous layer 302 may vary from application to application and may depend on such factors as desired insulating properties of layer 302, type of monocrystalline material comprising layer 106, and the like. In accordance with one exemplary aspect of the present embodiment, layer 302 thickness is about 2 nm to about 100 nm, preferably about 2-10 nm, and more preferably about 5-6 nm.

Referring again to FIGS. 1-4, substrate 102 is a monocrystalline substrate such as a monocrystalline silicon or gallium arsenide substrate. The crystalline structure of the monocrystalline substrate is characterized by a lattice constant and by a lattice orientation. In similar manner, accommodating buffer layer 104 is also a monocrystalline material and the lattice of that monocrystalline material is characterized by a lattice constant and a crystal orientation. The lattice constants of the accommodating buffer layer and the monocrystalline substrate must be closely matched or, alternatively, must be such that upon rotation of one crystal orientation with respect to the other crystal orientation, a substantial match in lattice constants is achieved. In this context the terms “substantially equal” and “substantially matched” mean that there is sufficient similarity between the lattice constants to permit the growth of a high quality crystalline layer on the underlying layer.

FIG. 5 illustrates graphically the relationship of the achievable thickness of a grown crystal layer of high crystalline quality as a function of the mismatch between the lattice constants of the host crystal and the grown crystal. Curve 502 illustrates the boundary of high crystalline quality material. The area to the right of curve 502 represents layers that have a large number of defects. With no lattice mismatch, it is theoretically possible to grow an infinitely thick, high quality epitaxial layer on the host crystal. As the mismatch in lattice constants increases, the thickness of achievable, high quality crystalline layer decreases rapidly. As a reference point, for example, if the lattice constants between the host crystal and the grown layer are mismatched by more than about 2%, monocrystalline epitaxial layers in excess of about 20 nm cannot be achieved.

In accordance with one embodiment of the invention, substrate 102 is a (100) or (111) oriented monocrystalline silicon wafer and accommodating buffer layer 104 is a layer of strontium barium titanate. Substantial matching of lattice constants between these two materials is achieved by rotating the crystal orientation of the titanate material by 45° with respect to the crystal orientation of the silicon substrate wafer. The inclusion in the structure of amorphous interface layer 110, a silicon oxide layer in this example, if it is of sufficient thickness, serves to reduce strain in the titanate monocrystalline layer that might result from any mismatch in the lattice constants of the host silicon wafer and the grown titanate layer. As a result, in accordance with an embodiment of the invention, a high quality, thick, monocrystalline titanate layer is achievable.

Referring now to FIGS. 1, 3, and 4, layer 106 is a layer of epitaxially grown monocrystalline material and that crystalline material is also characterized by a crystal lattice constant and a crystal orientation. In accordance with one embodiment of the invention, the lattice constant of layer 106 differs from the lattice constant of substrate 102. To achieve high crystalline quality in this epitaxially grown monocrystalline layer, the accommodating buffer layer must be of high crystalline quality. In addition, in order to achieve high crystalline quality in layer 106, substantial matching between the crystal lattice constant of the host crystal, in this case, the monocrystalline accommodating buffer layer, and the grown crystal is desired. With properly selected materials this substantial matching of lattice constants is achieved as a result of rotation of the crystal orientation of the grown crystal with respect to the orientation of the host crystal. Similarly, the lattice constant of layer 108 is preferably closely matched to the lattice constant of layer 106, to allow epitaxial growth of layer 108 overlying layer 106.

The following example illustrates a process, in accordance with one embodiment of the invention, for fabricating a semiconductor structure such as the structures depicted in FIGS. 1-4. The process starts by providing a monocrystalline semiconductor substrate comprising silicon or germanium. In accordance with a preferred embodiment of the invention, the semiconductor substrate is a silicon wafer having a (100) orientation. The substrate is preferably oriented on axis or, at most, about 4° off axis. At least a portion of the semiconductor substrate has a bare surface, although other portions of the substrate, as described below, may encompass other structures. The term “bare” in this context means that the surface in the portion of the substrate has been cleaned to remove any oxides, contaminants, or other foreign material. As is well known, bare silicon is highly reactive and readily forms a native oxide. The term “bare” is intended to encompass such a native oxide. A thin silicon oxide may also be intentionally grown on the semiconductor substrate, although such a grown oxide is not essential to the process in accordance with the invention. In order to epitaxially grow a monocrystalline oxide layer overlying the monocrystalline substrate, the native oxide layer must first be removed to expose the crystalline structure of the underlying substrate. The following process is preferably carried out by molecular beam epitaxy (MBE), although other epitaxial processes may also be used in accordance with the present invention. The native oxide can be removed by first thermally depositing a thin layer of strontium, barium, a combination of strontium and barium, or other alkali earth metals or combinations of alkali earth metals in an MBE apparatus. In the case where strontium is used, the substrate is then heated to a temperature of about 850° C. to cause the strontium to react with the native silicon oxide layer. The strontium serves to reduce the silicon oxide to leave a silicon oxide-free surface. The resultant surface, which exhibits an ordered 2×1 structure, includes strontium, oxygen, and silicon. The ordered 2×1 structure forms a template for the ordered growth of an overlying layer of a monocrystalline oxide. The template provides the necessary chemical and physical properties to nucleate the crystalline growth of an overlying layer.

In accordance with an alternate embodiment of the invention, the native silicon oxide can be converted and the substrate surface can be prepared for the growth of a monocrystalline oxide layer by depositing an alkali earth metal oxide, such as strontium oxide, strontium barium oxide, or barium oxide, onto the substrate surface by MBE at a low temperature and by subsequently heating the structure to a temperature of about 850° C. At this temperature a solid state reaction takes place between the strontium oxide and the native silicon oxide, causing the reduction of the native silicon oxide and leaving an ordered 2×1 structure with strontium, oxygen, and silicon remaining on the substrate surface. Again, this forms a template for the subsequent growth of an ordered monocrystalline oxide layer.

Following the removal of the silicon oxide from the surface of the substrate, in accordance with one embodiment of the invention, the substrate is cooled to a temperature in the range of about 200-800° C. and a layer of strontium titanate is grown on the template layer by molecular beam epitaxy. The MBE process is initiated by opening shutters in the MBE apparatus to expose strontium, titanium and oxygen sources. The ratio of strontium and titanium is approximately 1:1. The partial pressure of oxygen is initially set at a minimum value to grow stochiometric strontium titanate at a growth rate of about 0.3-0.5 nm per minute. After initiating growth of the strontium titanate, the partial pressure of oxygen is increased above the initial minimum value. The overpressure of oxygen causes the growth of an amorphous silicon oxide layer at the interface between the underlying substrate and the growing strontium titanate layer. The growth of the silicon oxide layer results from the diffusion of oxygen through the growing strontium titanate layer to the interface where the oxygen reacts with silicon at the surface of the underlying substrate. The strontium titanate grows as an ordered monocrystal with the crystalline orientation rotated by 45° with respect to the ordered 2×1 crystalline structure of the underlying substrate. Strain that otherwise might exist in the strontium titanate layer because of the small mismatch in lattice constant between the silicon substrate and the growing crystal is relieved in the amorphous silicon oxide intermediate layer.

After the strontium titanate layer has been grown to the desired thickness, the monocrystalline strontium titanate is capped by a template layer that is conducive to the subsequent growth of an epitaxial layer of a desired monocrystalline material. For example, for the subsequent growth of a monocrystalline piezoelectric material layer, the MBE growth of the strontium titanate monocrystalline layer can be capped by terminating the growth with 1-2 monolayers of titanium, 1-2 monolayers of titanium-oxygen or with 1-2 monolayers of strontium-oxygen.

Following the formation of the template, the piezoelectric layer is formed using a spin-on, sol-gel coating technique, then calcined and crystallized between 450° C. and 800° C. to form a monocrystalline layer 106. Layer 106 may also be formed using physical vapor deposition (PVD), pulsed laser deposition (PLD), or chemical vapor deposition (CVD) techniques. Layer 108 is then grown using MBE techniques, to a desired thickness, by introducing Ga and As into a MBE reaction chamber.

In accordance with the embodiment illustrated in FIG. 2, a GaAs layer may be formed overlying the accommodating buffer layer by terminating the growth of the accommodating buffer layer with 1-2 monolayers of titanium, 1-2 monolayers of titanium-oxygen or with 1-2 monolayers of strontium-oxygen. Following the formation of this capping layer, arsenic is deposited to form a Ti—As bond, a Ti—O—As bond or a Sr—O—As.

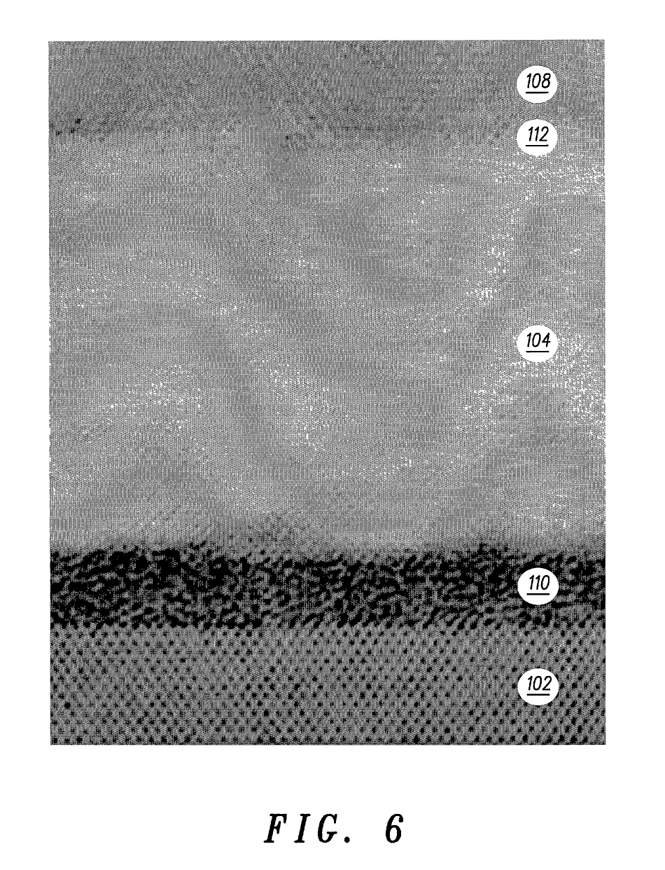

FIG. 6 is a high resolution Transmission Electron Micrograph (TEM) of semiconductor material manufactured in accordance with one embodiment of the present invention. Single crystal SrTiO₃ accommodating buffer layer 104 was grown epitaxially on silicon substrate 102. During this growth process, amorphous interfacial layer 110 is formed which relieves strain due to lattice mismatch. GaAs compound semiconductor layer 108 was then grown epitaxially using template layer 112.

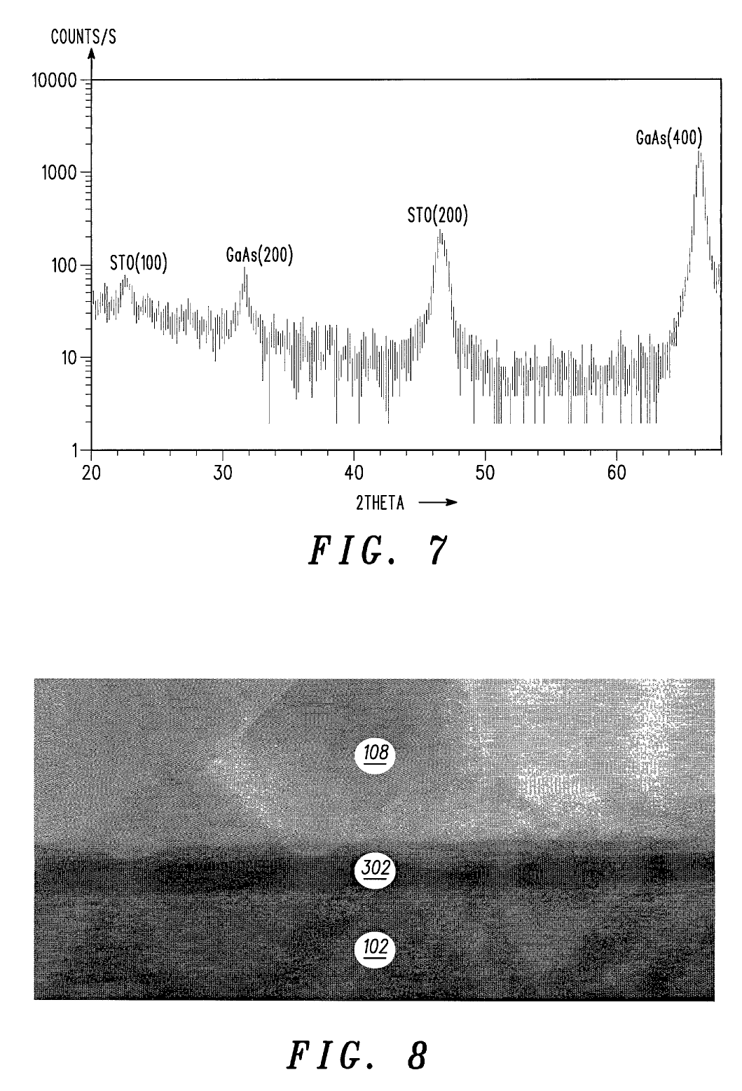

FIG. 7 illustrates an x-ray diffraction spectrum taken on a structure including GaAs monocrystalline layer 108 comprising GaAs grown on silicon substrate 102 using accommodating buffer layer 104. The peaks in the spectrum indicate that both the accommodating buffer layer 104 and GaAs compound semiconductor layer 106 are single crystal and (100) orientated.

Structure 300, illustrated in FIG. 3, may be formed by growing an accommodating buffer layer, forming an amorphous oxide layer over substrate 102, and growing at least a portion of layer 106 (or 108) over the accommodating buffer layer, as described above. The accommodating buffer layer and the amorphous oxide layer are then exposed to an anneal process sufficient to change the crystalline structure of the accommodating buffer layer from monocrystalline to amorphous, thereby forming an amorphous layer such that the combination of the amorphous oxide layer and the now amorphous accommodating buffer layer form a single amorphous oxide layer 302. any remaining portion(s) of layer 106 or layer 108 are then subsequently grown over the initial portion of layer 106 or layer 108. Alternatively, the anneal process may be carried out subsequent to growth of all of layer 106 and/or layer 108.

In accordance with one aspect of this embodiment, layer 302 is formed by exposing substrate 102, the accommodating buffer layer, the amorphous oxide layer, and at least a portion of layer 106 to a rapid thermal anneal process with a peak temperature of about 700° C. to about 1000° C. and a process time of about 5 seconds to about 10 minutes. However, other suitable anneal processes may be employed to convert the accommodating buffer layer to an amorphous layer in accordance with the present invention. For example, laser annealing, electron beam annealing, or “conventional” thermal annealing processes (in the proper environment) may be used to form layer 302.

FIG. 8 is a high resolution TEM of semiconductor material manufactured in accordance with the embodiment of the invention illustrated in FIG. 3, except layers 108 and 106 are transposed as described above, such that layer 108 is formed overlying the accommodating buffer layer. In accordance with this embodiment, a single crystal SrTiO₃ accommodating buffer layer was grown epitaxially on silicon substrate 102. During this growth process, an amorphous interfacial layer forms as described above. Next, at least a portion of layer 108, comprising a compound semiconductor layer of GaAs, is formed above the accommodating buffer layer and the accommodating buffer layer is exposed to an anneal process to form amorphous oxide layer 302.

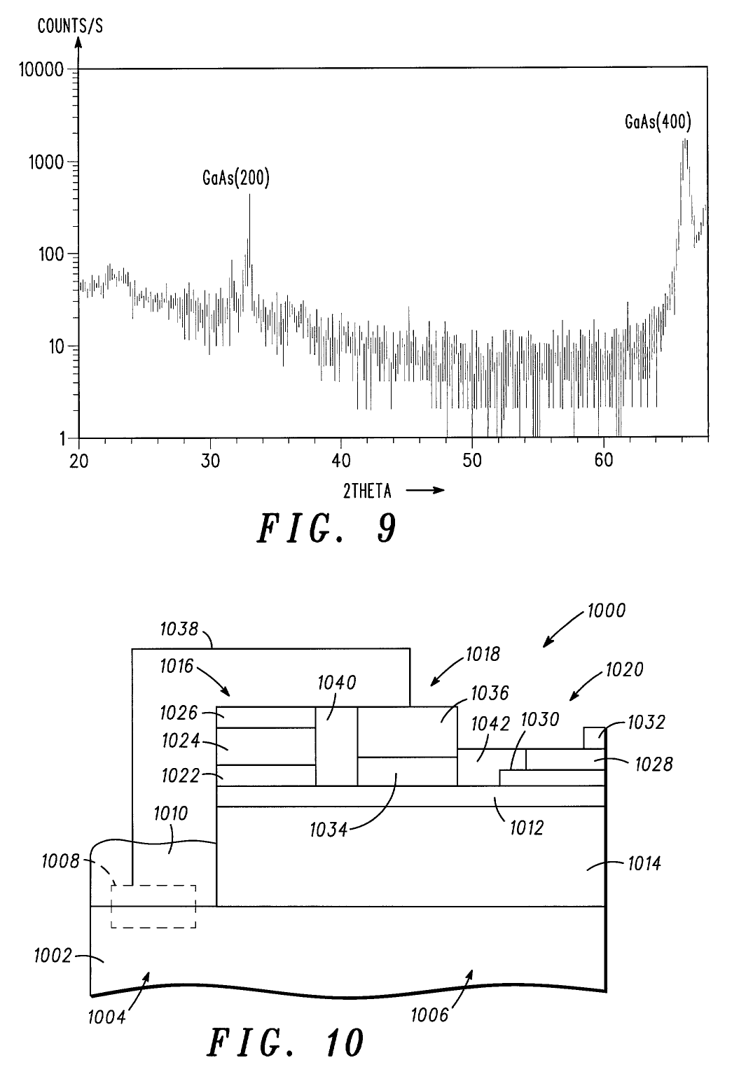

FIG. 9 illustrates an x-ray diffraction spectrum taken on a structure including a GaAs compound semiconductor layer and amorphous oxide layer 302 formed on silicon substrate 102. The peaks in the spectrum indicate that GaAs compound semiconductor layer 1088 is single crystal and (100) orientated and the lack of peaks around 40 to 50 degrees indicates that layer 302 is amorphous.

The process described above illustrates a process for forming a semiconductor structure including a silicon substrate, an overlying oxide layer, and a monocrystalline material layer comprising a gallium arsenide compound semiconductor layer by the process of molecular beam epitaxy. The process can also be carried out by the process of CVD, PVD, metal organic chemical vapor deposition (MOCVD), migration enhanced epitaxy (MEE), atomic layer epitaxy (ALE), chemical solution deposition (CSD), pulsed laser deposition (PLD), or the like. Further, by a similar process, other monocrystalline accommodating buffer layers such as alkaline earth metal titanates, zirconates, hafnates, tantalates, vanadates, ruthenates, and niobates, peroskite oxides such as alkaline earth metal tin-based perovskites, lanthanum aluminate, lanthanum scandium oxide, and gadolinium oxide can also be grown. Further, by a similar process such as MBE, other monocrystalline acousto-optic layers comprising other III-V and II-VI monocrystalline compound semiconductors, semiconductors, metals and non-metals can be deposited overlying the monocrystalline oxide accommodating buffer layer.

FIG. 10 illustrates schematically, in cross section, a device structure 1000, including an acousto-optic device and other microelectronic devices monolithically formed on a single substrate, in accordance with a further embodiment of the invention. Device structure 1000 includes a monocrystalline semiconductor substrate 1002, preferably a monocrystalline silicon, germanium, or gallium arsenide wafer. Monocrystalline semiconductor substrate 1002 includes two regions, 1004 and 1006. An electrical semiconductor component generally indicated by the dashed line 1008 is formed, at least partially, in region 1004. Electrical component 1008 can be a resistor, a capacitor, an active semiconductor component such as a diode or a transistor or an integrated circuit such as a CMOS integrated circuit. For example, electrical semiconductor component 1008 can be a CMOS integrated circuit configured to perform digital signal processing or another function for which silicon integrated circuits are well suited. The electrical semiconductor component in region 1004 can be formed by conventional semiconductor processing as is well known and widely practiced in the semiconductor industry. A layer of insulating material 1010 such as a layer of silicon oxide or the like may overlie electrical semiconductor component 1008.

Insulating material 1010 and any other layers that may have been formed or deposited during the processing of semiconductor component 1008 in region 1004 are removed from the surface of region 1006 to provide a bare silicon surface in that region. As is well known, bare silicon surfaces are highly reactive and a native silicon oxide layer can quickly form on the bare surface. A layer of barium or barium and oxygen is deposited onto the native oxide layer on the surface of region 1006 and is reacted with the oxidized surface to form a first template layer (not shown). In accordance with one embodiment of the invention a monocrystalline oxide layer is formed overlying the template layer by a process of molecular beam epitaxy. Reactants including barium, titanium and oxygen are deposited onto the template layer to form the monocrystalline oxide layer. During the deposition, the partial pressure of oxygen is initially set near the minimum necessary to fully react with the barium and titanium to form the monocrystalline barium titanate layer. As the monocrystalline oxide forms, the partial pressure of oxygen is increased to form an amorphous layer between the growing crystalline layer and the substrate.

In accordance with an embodiment of the invention, the step of depositing the monocrystalline oxide layer is terminated by forming a layer 1012, which includes 1-10 monolayers of titanium, barium, strontium, barium and oxygen, titanium and oxygen, or strontium and oxygen, and may additionally include a surfactant (e.g., 1-2 monolayers of Al) and/or a cap layer as discussed above. Next, a thin cap layer (not shown) is deposited over layer 1012, and the structure is exposed to an anneal process to form an amorphous layer 1014 comprising accommodating buffer layer and amorphous oxide layer material.

In accordance with one aspect of the present embodiment, after layer 1012 and the cap layer formation, a light emitter 1016, an acousto-optic device 1018, and a light detector 1020 may be formed over the silicon substrate. Exemplary device structures in accordance with alternate embodiment may include an acousto-optic device and any combination of devices 1008, 1016, and 1020.

Emitting device 1016 is formed using one or more compound semiconductor material layers such as layer 108 described above in connection with FIGS. 1-4. In accordance with exemplary embodiments of the invention, device 1016 includes a laser, such as an edge emitting laser or a vertical cavity surface emitting laser (VCSEL), or a light emitting diode formed using one or more compound semiconductor layers.

In accordance with one aspect of the invention, emitter 1016 is an edge emitting laser, including a first cladding layer 1022, an active region 1024, and a second cladding layer 1026. Layers 1022-1026 may be formed of any suitable semiconductor material such as compound semiconductor materials discussed above in connection with layer 108. For example, first cladding layer 1022 may include n-type doped AlGaAs, active layer 1024 may include GaAs, and second cladding layer 1026 may include p-doped AlGaAs, where each of layer 1022-1026 is epitaxially formed over substrate 1002.

In accordance with an exemplary embodiment of the invention, detector 1020 includes an active region 1028 and contacts 1030 and 1032. Active region 1028 may be formed of a variety of crystalline, polycrystalline, or amorphous materials such as silicon, GaAs, and InGaAs; however, in accordance with one embodiment of the present invention, region 1028 is formed of the same material used to form region 1024 of emitter 1016, such as monocrystalline GaAs. Contacts 1030 and 1032 may be formed of any conductive material; however, contact 1030 is preferably formed of a monocrystalline material such as monocrystalline n+ GaAs, which supports monocrystalline growth of material for layer 1028.

Acousto-optic device 1018 includes a piezoelectric layer 1034 and an acousto-optic layer 1036. Device 1018 may be formed using the method described above in connection with forming the structure of FIG. 3, with an additional step or steps of etching the piezoelectric and acousto-optic material layers. In accordance with one aspect of the invention, layer 1036 includes the same material used to form regions 1024 and/or 1028.

Device 1008 and acousto-optic device 1018 may be coupled using an interconnect represented as line 1038. Similarly other devices such as devices 1016 and 1020 may be connected to device 1008 or other devices formed within or using substrate 1002 material using similar interconnects.

Structure 1000 may also include waveguides 1040 and 1042 interposed, respectively, between emitter 1016 and acousto-optic device 1018 and between acousto-optic device 1018 and detector 1020. Waveguides 1040 and 1042 may be formed of any suitable material such as oxides or air. In accordance with one embodiment of the invention, waveguides 1040 and 1042 are formed of an oxide such as an oxide material described above in connection with accommodating buffer layer 104.

Although illustrative structure 1000 has been described as a structure formed on a silicon substrate 1002 and having a barium (or strontium) titanate layer, similar devices can be fabricated using other monocrystalline substrates, accommodating buffer layers and other monocrystalline material layers as described elsewhere in this disclosure.

Clearly, those embodiments specifically describing structures having acousto-optic portions and piezoelectric portions, are meant to illustrate embodiments of the present invention and not limit the present invention. There are a multiplicity of other combinations and other embodiments of the present invention. For example, the present invention includes structures and methods for fabricating material layers which form semiconductor structures, devices and integrated circuits including other layers such as metal layers. More specifically, the invention includes structures and methods for forming a compliant substrate which is used in the fabrication of semiconductor structures, devices and integrated circuits and the material layers suitable for fabricating those structures, devices, and integrated circuits. By using embodiments of the present invention, it is now simpler to integrate devices that include acousto-optic devices as well as other material layers that are used to form those devices with other components that work better or are easily and/or inexpensively formed. This allows a device to be shrunk, the manufacturing costs to decrease, and yield and reliability to increase.

In accordance with one embodiment of this invention, a monocrystalline semiconductor or compound semiconductor wafer can be used in forming acousto-optic devices over the wafer. In this manner, the wafer is essentially a “handle” wafer used during the fabrication of acousto-optic devices. Therefore, the acousto-optic devices can be formed over a wafer of at least approximately 200 millimeters in diameter and possibly at least approximately 300 millimeters.

By the use of this type of substrate, a relatively inexpensive “handle” wafer overcomes the fragile nature of piezoelectric, acousto-optic or other monocrystalline material wafers by placing the device over a relatively more durable and easy to fabricate base material. Fabrication costs for acousto-optic devices should decrease because larger substrates can be processed more economically and more readily compared to the relatively smaller and more fragile substrates.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A semiconductor structure comprising:
a monocrystalline substrate;
an accommodating buffer layer formed on the substrate;
a template formed on the accommodating buffer layer;
a piezoelectric material layer overlying the accommodating buffer layer; and
an acousto-optic material layer adjacent the piezoelectric material layer.

2. The semiconductor structure of claim 1, wherein the piezoelectric material layer is between the accommodating buffer layer and the acousto-optic material layer.

3. The semiconductor structure of claim 1, wherein the acousto-optic material layer is between the accommodating buffer layer and the piezoelectric material layer.

4. The semiconductor structure of claim 1, wherein the acousto-optic material layer includes material selected from the group consisting of GaAs, Ge, and TeO₂.

5. The semiconductor structure of claim 1, wherein the acousto-optic material layer comprises GaAs.

6. The semiconductor structure of claim 1, wherein the piezoelectric material layer comprises one of Pb(Zr,Ti)0₃ and Pb(Mg,Nb)O₃—PbTiO₃.

7. The semiconductor structure of claim 1, further comprising a surfactant.

8. The semiconductor structure of claim 7, wherein the surfactant comprises at least one of Al, In, and Ga.

9. The semiconductor structure of claim 7, wherein the template layer further comprises a capping layer.

10. The semiconductor structure of claim 9, wherein the capping layer comprises at least one of As, P, Sb, and N.

11. The semiconductor structure of claim 9, wherein the surfactant comprises Al, the capping layer comprises Al₂Sr, and acousto-optic material layer comprises GaAs.

12. The semiconductor structure of claim 1, wherein the accommodating buffer layer comprises an oxide selected from the group consisting of alkaline earth metal titanates, alkaline earth metal zirconates, alkaline earth metal hafniates, alkaline earth metal tantalates, alkaline earth metal ruthenates, and alkaline earth metal niobates.

13. The semiconductor structure of claim 1, wherein the accommodating buffer layer comprises SrₓBa₁₋ₓTiO₃ where x ranges from 0 to 1.

14. The semiconductor structure of claim 1, wherein the accommodating buffer layer comprises an oxide formed as a monocrystalline oxide and subsequently heat treated to convert the monocrystalline oxide to an amorphous oxide.

15. The semiconductor structure of claim 1, further comprising a amorphous oxide layer formed between the first monocrystalline semiconductor layer and the accommodating buffer layer.

16. The semiconductor structure of claim 15, wherein the monocrystalline substrate comprises silicon and the amorphous oxide layer comprises a silicon oxide.

17. The semiconductor structure of claim 1, wherein the accommodating buffer layer has a thickness of about 2-10 nm.

18. The semiconductor structure of claim 1, further comprising a microelectronic device formed using the monocrystalline substrate.

19. The semiconductor structure of claim 1, wherein the monocrystalline substrate comprises silicon.

20. A semiconductor structure comprising:
a monocrystalline substrate;
an accommodating buffer layer formed on the substrate;
a template formed on the accommodating buffer layer;
a piezoelectric structure overlying the accommodating buffer layer; and
an acousto-optic structure adjacent the piezoelectric material layer.

21. The semiconductor structure of claim 20, wherein the piezoelectric structure and the acousto-optic structure are both in contact with the template layer.

22. The semiconductor structure of claim 20, wherein the acousto-optic structure includes material selected from the group consisting of GaAs, Ge, and TeO₂.

23. The semiconductor structure of claim 20, wherein the acousto-optic structure comprises GaAs.

24. The semiconductor structure of claim 20, wherein the piezoelectric structure comprises one of Pb(Zr,Ti)O₃ and Pb(Mg,Nb)O₃—PbTiO₃.

25. The semiconductor structure of claim 20, wherein the monocrystalline substrate comprises silicon.

26. An acousto-optic device structure comprising:
a monocrystalline substrate;
an accommodating buffer structure formed on the substrate; and
an acousto-optic device monolithically formed overlying the accommodating buffer layer.

27. The acousto-optic device structure of claim 26, wherein the monocrystalline substrate comprises silicon.

28. The acousto-optic device structure of claim 26, wherein the accommodating buffer layer comprises an oxide selected from the group consisting of alkaline earth metal titanates, alkaline earth metal zirconates, alkaline earth metal hafniates, alkaline earth metal tantalates, alkaline earth metal ruthenates, and alkaline earth metal niobates.

29. The acousto-optic device structure of claim 26, wherein the accommodating buffer layer is amorphous.

30. The acousto-optic device structure of claim 26, wherein the accommodating buffer layer is monocrystalline.

31. The acousto-optic device structure of claim 26, further comprising a light emitting device.

32. The acousto-optic device structure of claim 31, wherein the light emitting device is monolithically formed overlying the monocrystalline substrate.

33. The acousto-optic device structure of claim 26, further comprising a light detecting device.

34. The acousto-optic device structure of claim 33, wherein the light detecting device is monolithically formed overlying the monocrystalline substrate.

35. A process for fabricating an acousto-optic structure comprising the steps of:
providing a monocrystalline substrate;
epitaxially growing a monocrystalline accommodating buffer layer overlying the monocrystalline substrate;
epitaxially growing a piezoelectric material over the monocrystalline accommodating buffer layer overlying; and
epitaxially growing an acousto-optic material over the monocrystalline accommodating buffer layer overlying.

36. The process of claim 35, wherein the step of providing includes providing a silicon substrate.

37. The process of claim 35, further comprising the step of exposing a portion of the structure to an anneal process to convert the monocrystalline accommodating buffer layer to an amorphous structure.

38. The process of claim 35, further comprising the step of forming an amorphous layer between the accommodating buffer layer and the monocrystalline substrate.

39. The process of claim 35, further comprising the step of etching the piezoelectric material and the acousto-optic material to form an acousto-optic device.

40. The process of claim 35, further comprising the step of epitaxially forming a light emitting device overlying the monocrystalline substrate.

41. The process of claim 35, further comprising the step of epitaxially forming a light detecting device overlying the monocrystalline substrate.

42. The process of claim 35, further comprising the step of epitaxially forming a microelectronic device using a portion of the monocrystalline substrate.
